(19) United States
(12) Patent Application Publication
(10) Pub. No.: US 2013/0334206 A1
(43) Pub. Date: Dec. 19, 2013

(54) GRAPHITE HEATER

(71) Applicant: Shin-Etsu Chemical Co., Ltd., Tokyo (JP)

(72) Inventor: Koji Kato, Annaka-shi (JP)

(21) Appl. No.: 13/912,659

(22) Filed: Jun. 7, 2013

(30) Foreign Application Priority Data
Jun. 19, 2012 (JP) 2012-137673

(51) Int. Cl. H05B 3/14; H05B 3/03

(52) U.S. Cl. CPC H05B 3/145; H05B 3/03
USPC 219/541; 219/553

(57) ABSTRACT

A graphite heater having a high temperature strength is proposed, which undergoes little thermal deformation such as distortion and warping, and has an electric resistance comparable to a conventional graphite heater of same size, for it has grooves extending lengthwise and at least one nodal partition formed between neighboring ones of the grooves.

### FIELD OF TECHNOLOGY

The present invention relates to an improved graphite heater useful for heating a semiconductor substrate in a semiconductor substrate processor or a substrate growth device or the like in which CVD (chemical vapor deposition) and/or other treatment are conducted.

### BACKGROUND TECHNOLOGY

A crystalline or single-crystalline thin layer of a semiconductor substrate is in general prepared by first growing it over another substrate or a substrate of the same material as itself by CVD method utilizing plasma, ultraviolet laser beam, or the like, or by evaporation method or MBE method utilizing electron beam, or any of PVD methods utilizing magnetron such as sputtering and pulse laser evaporation.

In preparation of a thin film like this, temperature is of a special importance among other preparation conditions, and it is not possible to grow a thin crystal or single crystal film unless the substrate is maintained at a certain temperature or higher. Especially in the case of the next generation type wide band gap semiconductor devices made of SiC, GaN, ZnO and the like, which have melting points as high as about 2500, 1900 and 1700 degrees C., respectively, unlike Si which melts at about 1400 degrees C., it is necessary to raise the temperature to an extreme height in order to produce sublimation and bulk body. If certain growing methods are adopted, it is possible to grow a film of these at a substrate temperature lower than the above-named, but even then it is necessary to heat up to such extremely high temperatures as 1000-1300 degrees C.

In growing a film layer or making elements (devices), it is indispensable to prepare a high quality thin film, and to this end it is a very important requirement to minimize the admixing of impurities, so that there is a need for a clean ultrahigh temperature heater which does not evaporate at extremely high temperatures. Examples of ultrahigh temperature heaters meeting this requirement include metallic heaters made of W and/or Mo, but such metallic heaters are criticized for the reason that when they are used in vacuum the oxides formed in their surfaces evaporate and pollute the heated items by entering them as impurities.

Besides metallic heaters, there are known graphite heaters. With a graphite heater it is possible to minimize the admixing of impurities during the high purity treatment at high temperatures; however, a problem is that when exposed to corrosive gases such as ammonia and hydrogen at high temperatures the graphite heater is easily eroded, so that graphite heaters are in practice used only after their surfaces are coated with an anticorrosion layer.

Also, it is preferred that a heater used for applying a high purity treatment to a semiconductor substrate at a high temperature is hard to deform during the high temperature treatment and has a high heating power, in addition to the quality of satisfying the requirement of minimizing the admixing of impurities. Even if a heater satisfies the requirement regarding the contamination by impurities, if its resistance value is low, the heating must be conducted at a low voltage and large current so as to attain the required heat release so that it becomes necessary to procure a new electric source to meet this heating pattern, and as a result the manufacturing cost rises.

In order to cope with this problem, there is a measure for increasing the heat release by heightening the electric resistance value of the heater through an adjustment of the length and cross-sectional area of the heater, based on the theory that the electric resistance value of a heater is determined by the following equation:

(resistance value)=(specific resistance)×(length)/(cross-sectional area).

For example, IP Publication 1 describes that it is possible to increase the heat release while maintaining the length of heater pattern and the current carrying capacity unchanged through making the cross section in a concaved or a convex shape.

Also, IP Publication 2 describes about a graphite heater whose electric resistance is increased by making its heating side face of the heater smooth and the opposite side face concaved thereby rendering the cross-sectional area smaller.

### PRIOR ART PUBLICATIONS

### IP Publications

### [IP Publication 1]

(Japanese) Patent Application Publication 2005-217317

### [IP Publication 2]

(Japanese) Patent Publication No. 4690297

### BRIEF DESCRIPTION OF THE INVENTION

### Problems the Invention Seeks to Solve

However, in the case of the carbon heater described in IP Publication 1, the length is made large so as to increase the resistance, but if the length is excessive, the heater becomes easy to break and thus renders the handling a practical problem. Also, in the case of a rectangular heater described in IP Publication 2, a grooved hollow is formed in the lengthwise direction of the heater, in which direction the current runs, so that lowering of the resistance is restricted and at the same time by forming a rib on each side lowering of the strength of the heater itself is also restricted, but this heater is not yet unsatisfactory for industrial use.

As stated above, a graphite heater is liable to be eroded by gases such as ammonia and hydrogen, so that in practical use the heater surface is coated with a corrosion-resistant protective film; but if the heater is partially supported on the occasion of this coating treatment, the heater itself can bend under the self-imposed gravity and consequently the heater would have a warp, deformation and bend, and as a consequence of the thermal expansion caused during the high temperature treatment the heater itself would be further bent and would have a more extensive deformation and warp. When the graphite heater is thus deformed, it becomes difficult to set it in a heating apparatus, and as a result an unfavorable temperature distribution is created when such a heater is activated in the apparatus, and the heated product can end up having problematic properties.

The present invention was contrived in view of overcoming these circumstances, and hence it is an object of the present invention to provide a graphite heater which has a high strength at elevated temperatures, and does not incur deformations such as bending and warping while retaining an electric resistance comparable to conventional graphite heaters.

### Mans to Solve the Problems

The graphite heater according to the present invention is designed to attain the above-described objects and thus it is made to have a terminal area at each one of its ends and have a cross section with a substantial concavity, the cross section being taken across a plane vertical to the lengthwise direction in which current runs, characterized in that at least two grooves represented by the concavity are lined up in series in said lengthwise direction and that at least one partition is provided between neighboring ones of said at least two grooves, said partition extending crosswise to said lengthwise direction.

It is also a characteristic of the graphite heater of the present invention that an inter-terminal resistance measured between said terminal areas is 80% or greater but smaller than 100% of a resistance values R obtained by a following formula wherein ρ is a specific resistance of graphite, L is a distance between the terminal areas and S is a cross-sectional area of a concaved part of the heater:

R=ρ×L/S.

It is preferable that the surface of the graphite heater of the present invention is entirely or partly coated with a protective film layer, and it is also preferable that the protective film layer is made of an anticorrosive substance selected from PBN (pyrolytic boron nitride), PG (pyrolytic graphite), AlN and SiC.

### Effect of the Invention

According to the present invention, even though the graphite heater receives a coating treatment, deformation such as distortion, warping and bending of the heater itself is restricted, thanks to its partitions, and thus it is easy to fit it in an apparatus. Also as it is now possible to restrict the uneven distribution of heat release inside the apparatus, which is caused by the deformity of the heater, a stable production of products having good quality is enabled. Furthermore, according to the present invention, the resistance of the invented graphite heater is not substantially reduced compared to conventional graphite heaters, so that the operation can be conducted within the capacity of the existing power source for the heater, wherefore there is no need to prepare a new power source and thus there is a merit for the installation cost management.

### BRIEF DESCRIPTION OF DRAWINGS

FIG. 1 includes a schematic plan view of a graphite heater 1 of the present invention, a cross section of that part of the heater 1 where a partition 4 is, and a cross section of a groove 3.

FIG. 2 is a drawing showing positions of points used for an inter-terminal distance determination when the resistance is calculated and measured.

FIG. 3 is a drawing showing the distance between middle points of terminal areas used for measurement of distortion.

FIG. 4 includes schematic drawings showing various shapes of a part of the heater which constitutes a partition.

### EXAMPLES TO EMBODY THE INVENTION

Now, we will explain the graphite heater 1 of the present invention with reference to the drawings. FIG. 1 shows the configuration of the graphite heater 1 of the present invention. There are formed in this graphite heater 1 grooves 3 (concavities) which has a concaved cross section as taken orthogonally to the lengthwise direction, in which the electric current runs, and these grooves 3 are lined up in series in the lengthwise direction and that a partition 4 is provided between neighboring grooves 3.

This partition 4, which functions as a node, restricts the thermal expansion of the graphite heater 1 in directions including ones orthogonal to the lengthwise direction, as the heater 1 is coated at a high temperature, so that it is possible to substantially restrict the deformation such as bending, distortion and warping which conventional heaters are apt to experience when they thermally expand. In order to suppress the deformation caused by the thermal expansion, at least one partition 4 is provided to extend in the directions orthogonal to the lengthwise direction. FIG. 1 shows an example in which seven partitions are provided.

In the present invention, there is provided at least one partition 4 to extend in directions roughly orthogonal to the lengthwise direction, so that it is possible to increase the high temperature strength of the heater base material without lowering the resistance value of the heater base material way below the conventional heaters. Also, since the resistance value of the heater base material is not lowered way below the values of the conventional heaters, it is possible to use the existing power source designed for the conventional heaters as it is for the heater of the present invention and thus it is not necessary to install a new power source whereby an economical advantage is gained.

If a new power source is to be installed, the entire system must be re-designed and a huge cost is incurred; but according to the present invention, since the existing heater power source can be used as it is, there is no need for a special design change, and thus a lot of labor power is saved.

To check the overall resistance of the heater from lowering far below that of the conventional grooved heater, that is, a heater without a partition in the groove, it is advised to machine the grooves 3 leaving such amount of partitions (4) as to bring the resultant resistance value R to 80% or higher but lower than 100% of the conventionally grooved heater's resistance value R, and this inter-terminal resistance R of the graphite heater is calculated by the following equation wherein ] is a specific resistance of graphite, L is a distance between the terminal areas and S is a cross-sectional area of the grooved part of the heater:

R=ρ×L/S.

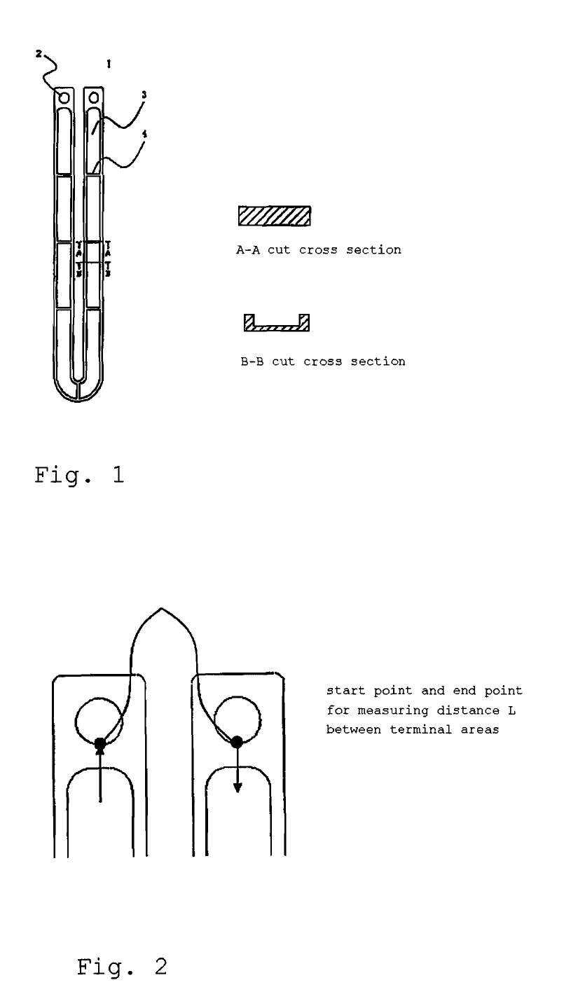

Here, the inter-terminal distance L is the distance between the points at which the imaginary straight lines extending lengthwise from the centers of the holes penetrating the terminals 2 meet the graphite, and as shown in FIG. 2, it is measured starting from the right point on the graphite to the left point along the length of the heater. The cross-sectional area of the concavity S is the area hatched in FIG. 1.

Although the number of the partition 4, which makes the node of the present invention, can be one at the least, it is possible to adjust the number depending on the length of the graphite heater, or other considerations. For example, in the case of a graphite heater having an overall length of 300-3000 mm, a width of 5-30 mm, and a thickness of 2-10 mm or so, it is preferable that the partitions 4, which make nodes, are 1-30 or so in number.

Also, it is preferable that the depth of the groove 3 is 0.5-8 mm or so, and that the width of the nodal partition 4 is 1-20 mm or so.

Also, the overall configuration of the graphite heater 1 of the present invention can be U letter-like, as shown in FIG. 1, but it may be of a different shape such as curved, straight-lined, or C letter-like, depending on the use circumstances.

Further, it is preferable that the nodal partition 4 of the present invention is arranged such that it extends orthogonally to the lengthwise direction of the heater, but it can be otherwise so long as the deformation by thermal expansion is restricted, and thus, when seen in the manner of FIG. 4, the partition can have slanted faces with respect to the lengthwise direction and may be composed of planar faces or rounded faces or both.

It is preferable that the graphite heater 1 of the present invention is coated all over or in part with such a protective film that can improve the anti-corrosiveness of the heater against corrosive gases and liquids. The protective film is preferably made of PBN (pyrolytic boron nitride), PG (pyrolytic graphite), AlN, or SiC, which are highly resistive, especially against ammonia and hydrogen.

### EXAMPLE 1

A terminal area 2 is made in each end of a graphite heater 1, measuring 600 mm in total length, 20 mm in width and 5 mm in thickness, by cutting a threaded through hole for electrical connection; then, in the lengthwise direction along which current runs, grooves 3 were formed which had a cross section such that the remnant graphite had a side wall thickness of 3 mm on each side and a bottom thickness of 1.5 mm. These grooves 3 were engraved in a manner such that a nodal partition 4 of a thickness of 10 mm was formed extending orthogonally to the current-passage lengthwise direction between each pair of neighboring grooves 3, and there were made seven partitions.

FIG. 1 is a plan view of the graphite heater 1 thus manufactured, and it shows a cross section of the nodal partition 4 and that part of the heater where the groove 3 is made. The cross section of the nodal partition 4 is a perfect rectangle, but the present invention does not require this and so long as the cross sectional area of the heater where the nodal partition 4 is made is greater than that where the groove 3 is made, there is no limit in the shape or size of the partition 4.

An inter-terminal resistance of the thus manufactured graphite heater 1 was measured with Milliohm High Tester 3540 manufactured by eDenki Co., Ltd. of Japan, and the resistance of the graphite heater 1 was found tobe 0.16 Ω. Incidentally, the positions used for the measurement were selected to represent the same distance as the calculation-purpose inter-terminal distance. As opposed to this, the resistance value R which is obtained by calculation is 0.176 Ω, namely, R=ρ×L/S=0.176 wherein ρ is 15 μΩ-m, L is 600 mm, and S is 51 mm²; so that the grooved graphite heater 1 with partitions had a resistance about 9% lower than the conventional partition-less graphite heater and as such it was possible to use the existing power source without inconvenience.

Next, in order to compare the degrees of distortion, warping and bending of graphite heaters as they are subjected to a coating treatment at an elevated temperature, another heater was made which had a groove without nodal partitions 4 as a comparative sample.

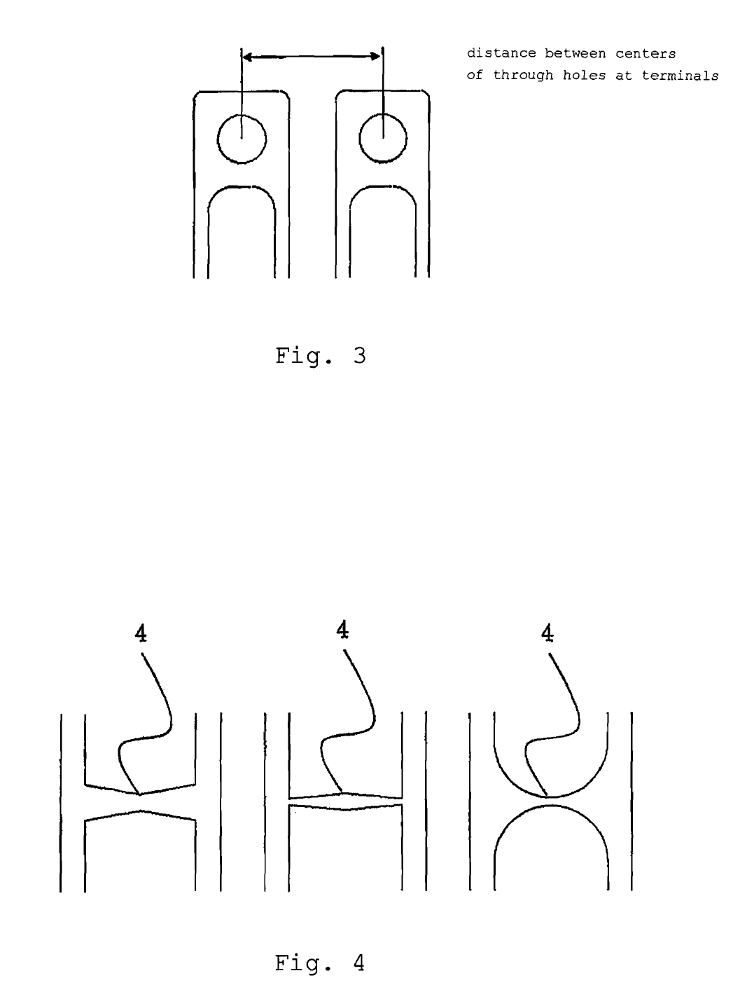

The graphite heater of the present invention which was formed with the nodal partitions 4 between the grooves 3 and the above-described comparative sample heater were each put in a vacuum furnace and were exposed to BCl₃ and NH₃ gases under conditions of 1800 degrees C. and 50 Pa whereby they were coated with an about 300 μm-thick PBN film. Before and after this coating treatment, the respective heaters were placed on a surface plate and their dimensions in maximum height and distance between middle points of the terminals 2 were measured with a three-coordinate measuring machine manufactured by Mitsutoyo Corp. of Japan, so as to find the changes in warping and distortion, respectively. FIG. 3 shows how the distance between the middle points of the terminal areas 2 is defined.

The result of the measurement was such that in the case of the graphite heater 1 of the present invention formed with the nodal partition 4, the warping increased by 0.31 mm and the distance between the middle points of the terminal areas 2 changed by 0.15 mm, and in the case of the comparative graphite heater without the nodal partitions, the warping increased by 0.45 mm and the distance between the middle points of the terminal areas 2 changed by 0.42 mm

Therefore, it was confirmed that the graphite heater 1 according to the present invention undergoes comparatively small warping and distortion when subjected to a high temperature coating treatment, so that the invention is found effective in restricting the deformation of the heater.

### EXAMPLE 2

Three graphite heaters were produced in the same manner as in Example 1, and these three heaters were coated with a 300 μm-thick film of PG, AlN or SiC, respectively, at different temperatures depending on the kind of the film. Same was done with three comparative graphite heaters without partitions 4. In all cases, the deformation was smaller in the case of the graphite heaters of the present invention in which nodal partitions 4 were formed than in the case of the comparative graphite heaters without the nodal partitions.

Therefore, it was confirmed that the present invention is also effective in the cases where the graphite heater 1 of the present invention is coated with a protective film of PG, AlN, SiC, etc. at different treatment temperatures.

### REPRESENTATION OF REFERENCE NUMERALS

1: graphite heater

2: terminal area

3: groove (concavity)

4: nodal partition

1. A graphite heater having an electrically connective terminal area at each one of its two ends and a cross section with a concavity, said cross section being taken across a plane vertical to the heater's lengthwise direction in which current runs, characterized in that at least two grooves represented by said concavity are lined up in series in said lengthwise direction and that at least one nodal partition is provided between neighboring ones of said at least two grooves, said partition extending crosswise to said lengthwise direction.

2. The graphite heater as claimed in claim 1, characterized in that a resistance measured between the two terminal areas of said graphite heater is 80% or greater but smaller than 100% of a resistance value R obtained from a following equation wherein ρ is a specific resistance of graphite, L is a distance between the terminal areas and S is a cross-sectional area of a concaved part of the heater:
R=ρ×L/S.

3. The graphite heater as claimed in claim 1 or 2, characterized in that the surface of the graphite heater is at least partly coated with a protective film layer.

4. The graphite heater as claimed in claim 3, characterized in that the protective film layer is made of an anticorrosive substance selected from PBN, PG, AlN and SiC.
